(19) United States
(12) Patent Application Publication
(10) Pub. No.: US 2002/0011139 A1
(43) Pub. Date: Jan. 31, 2002

(54) Cutting apparatus

(76) Inventor: Kevin Ross Inkster, Darlington (AU)

Correspondence Address: Scott A. Marks, Dorsey & Whitney LLP, 220 South Sixth Street, Minneapolis, MN, 55402-1498, US

(21) Appl. No.: 09/906,568

(22) Filed: Jul. 16, 2001

Related U.S. Application Data
(63) Continuation of application No. 09/028,875, filed on Feb. 24, 1998, now abandoned.

(30) Foreign Application Priority Data
Feb. 26, 1997 (AU) PO 5302

(51) Int. Cl. B26D 1/14

(52) U.S. Cl. 83/647.5; 83/676

(57) ABSTRACT

A cutting apparatus including a generally circular cutting member (1), and support means (2) for supporting the cutting member (1) for movement about a central area, wherein the cutting member (1) is driven in a rolling orbital motion about the central area during operation of the cutting apparatus.

The present invention is directed to cutting apparatus, and in particular to cutting apparatus for cutting hard material such as concrete and bricks.

Specialised cutting equipment has been developed for cutting such materials. In the Applicant's U.S. Pat. No. 5,456,011, there is disclosed a cutting tool incorporating two cutting members mounted side by side. This cutting tool is applicable for use in cutting hard materials. As the cutting members must be respectively moved for simultaneous oscillatory movements in opposing directions, this requires a relatively elaborate drive system for the cutting members. The power source for driving the cutting members must also be relatively large to take into account the acceleration forces generated by the movement of these cutting members. Furthermore, because a pair of cutting members are required, the width of the cut produced by the cutting tool will be relatively wide.

It would therefore be advantageous to provide a different type of cutting apparatus for cutting hard materials which can be relatively compact in size and which only requires a single cutting member.

With this in mind, the present invention provides a cutting apparatus including a generally circular cutting member, and a support means for supporting the cutting member for orbital movement about a central area, wherein the cutting member is driven in a rolling orbital motion about the central area during operation of the cutting apparatus.

The cutting member therefore moves in a similar fashion to the movement of a “hula hoop” about the central area.

The cutting member, may have a cutting edge, and each point on the cutting edge may be driven along a continuous convex scalloped path. Alternatively, each point on the cutting edge may be driven along a continuous concave scalloped path.

The support means may include a stator section and rotor section engaging the stator section for said rolling orbital motion therearound. The cutting member may be supported on the rotor section.

According to one preferred embodiment of the cutting apparatus according to the present invention, the stator section may be fixed to a body of the cutting apparatus, with the stator section having an outer wall. The rotor section may have an inner wall. The stator section outer wall and the rotor section inner wall may be at least substantially cylindrical, the diameter of the rotor section inner wall being greater than the diameter of the stator section outer wall. At least a portion of the outer wall of the stator section may be located within the confines of the inner wall of the rotor section such that a point contact is maintained between the inner and outer walls during said rolling orbital motion therebetween.

The rotor section may be rotatably supported on an axle. This axle may be rotatably supported on a moveable carriage. The moveable carriage may itself be slidably supported on a rotatably supported slide support. A power source may drive the slide support for rotational movement. The axis of rotation of the slide support may be laterally offset relative to the axis of rotation of the axle and therefore the rotor to thereby provide an offset drive arrangement.

When the slide support is driven, the offset drive arrangement results in orbital movement of the axle supported on the moveable carriage about the axis of rotation of the slide support. Because the rotor section is supported on the axle, centrifugal force may act to urge the outer cylindrical wall of the stator section against the inner cylindrical wall of the rotor section. Resilient means may also be provided to assist in urging together the inner and outer cylindrical walls. The resilient means may for example be in the form of a coil spring located between an end of the moveable carriage and the slide support to urge the inner cylindrical wall of the rotor section against the outer cylindrical wall of the stator section. This arrangement results in movement of the circular cutting member supported on the rotor section in a rolling motion about the stationery stator section.

Each point on the cutting edge of the cutting member may therefore move along the continuous scalloped path, with each of the scalloped portions of the path being convex in shape.

According to an alternative preferred embodiment of the cutting apparatus according to the present Invention, the stator section may be fixed to a body of the cutting apparatus, and the stator section may have an inner wall, with the rotor section having an outer wall. The rotor section outer wall and the stator section inner wall may be at least substantially cylindrical, the diameter of the rotor section outer wall being less than the diameter of the stator section inner wall. The rotor section may be supported on a moving carriage slidably supported on a slide support in a similar manner to the earlier offset drive arrangement. The principal difference is that at least a portion of the outer wall of the rotor section is located within the confines of the inner wall of the stator section. This also allows a point contact to be maintained between the inner and outer walls during said rolling orbital motion therebetween.

This configuration results in a somewhat different cutting path to the first embodiment. In particular, the cutting path of each point on the cutting edge of the cutting member may be defined by a plurality of concave scallops instead of convex scallops in the case of the first embodiment.

According to yet another preferred embodiment of the cutting apparatus according to the present invention, the central axis of the stator section may be driven for movement in an orbital path about a central rotational point and not fixed as in the earlier embodiments. The stator section may therefore move in an eccentric motion about the central rotational point. The rotor section may be located around the stator section. The movement of the rotor section in a rolling orbital motion about the stator section may be effected by the eccentric movement of the stator section such that the rotor section may “swing” about the stator section in the same manner that a hula hoop swings about the body of a user.

The stator section may include a stator housing having peripheral annular groove, and the rotor section may include an annular ring having an inner peripheral portion supported within the annular groove, a point contact being maintained between the base of the annular groove and the inner peripheral portion during said rolling orbital motion therebetween. The stator section may be driven for movement by an offset drive arrangement includes a drive shaft, a cam supported on the drive shaft and having an axis of symmetry laterally offset relative to the axis of rotation of the drive shaft, wherein the stator housing is supported on the cam for movement therewith.

This arrangement eliminates the need for the drive arrangement of the earlier arrangement incorporating the axle for supporting the rotor and the moveable carriage. The rotor may therefore move about the stator in a rolling motion at least entirely as a result of centrifugal force.

The above described embodiments preferably utilise relatively smooth cylindrical walls for the rotor section and stator section. It is however also envisaged that there be a positive drive between the stator and the rotor by for example, providing cooperating gear teeth respectively on the contacting walls.

Furthermore, it is envisaged that the stator and rotor may be held together by an offset weight arrangement.

The motion of the cutting member has a number of advantages:

a) The movement of the cutting member results in lateral oscillatory movement of the cutting edge of the cutting member. This allows a degree of impacting of the cutting member against the material being cut which facilitates the cutting of hard brittle material such as concrete.

b) The use of this cutting apparatus will be much safer because the cutting member will not readily cut any resilient material such as human flesh as the rotational speed of the cutting member can be relatively slow.

c) Because the cutting member moves in one rotational direction, this will allow the cutting member to continually throw out waste material from the cut during operation thereby preventing slogging of the cutting member. This also provides for a relatively simple drive arrangement for the cutting member.

d) The width of a cut made by the cutting apparatus will be less than the width of the cut produced by the Applicant's earlier cutting tool described in the above noted US patent.

e) When compared with the Applicant's earlier cutting tool, the cutting apparatus of the present invention can be relatively compact in size and could be held in one hand. This is in part because the cutting member needs to be driven in one direction only, and the power source for the cutting apparatus can be relatively smaller then the Applicant's earlier cutting tool. Furthermore, only one cutting member is required.

It will be convenient to further describe the invention by reference to the accompanying drawings which illustrate preferred embodiments of the present invention. Other embodiments of the invention are possible, and consequently the particularity of the accompanying drawings is not to be understood as superseding the generality of the preceding description of the invention.

In the drawings;

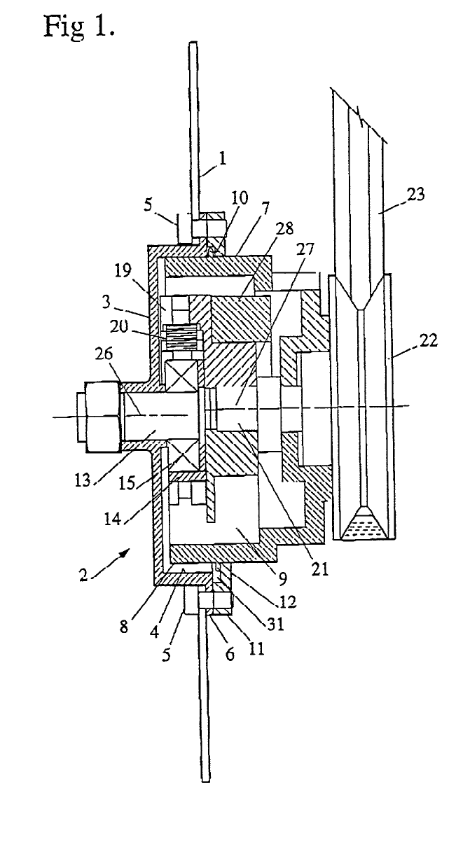

FIG. 1 is a side cross-sectional view of the support means of a first preferred embodiment of the cutting apparatus according to the present invention;

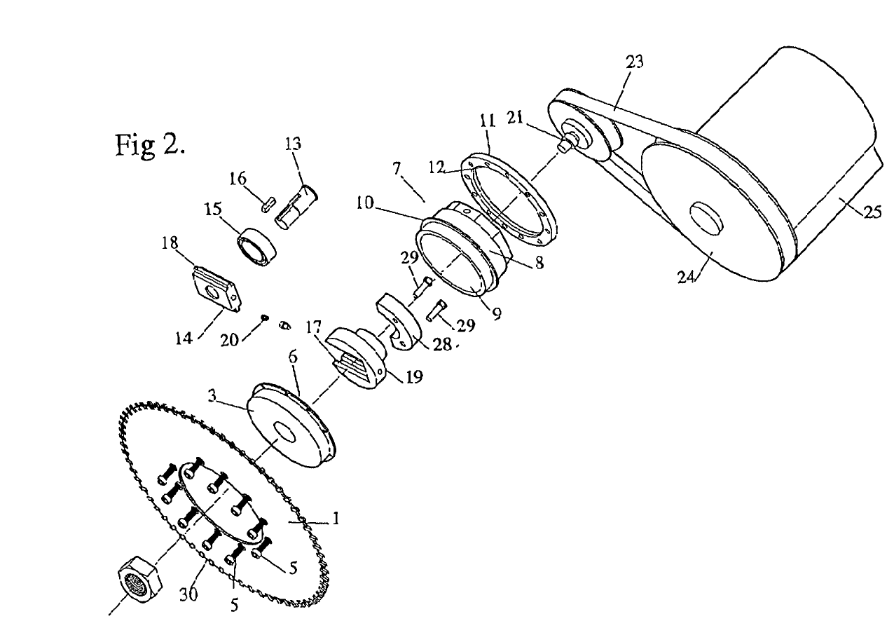

FIG. 2 is an exploded view of the support means, circular cutting member and driving means of the cutting apparatus of FIG. 1;

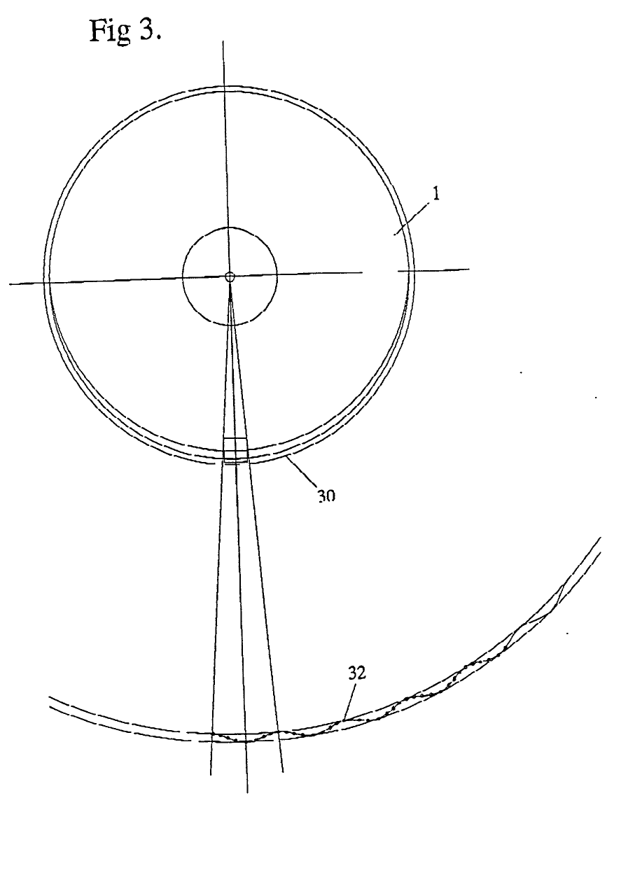

FIG. 3 is a diagram showing the path of movement of a point on the cutting edge of the cutting member supported on the support means of FIG. 1;

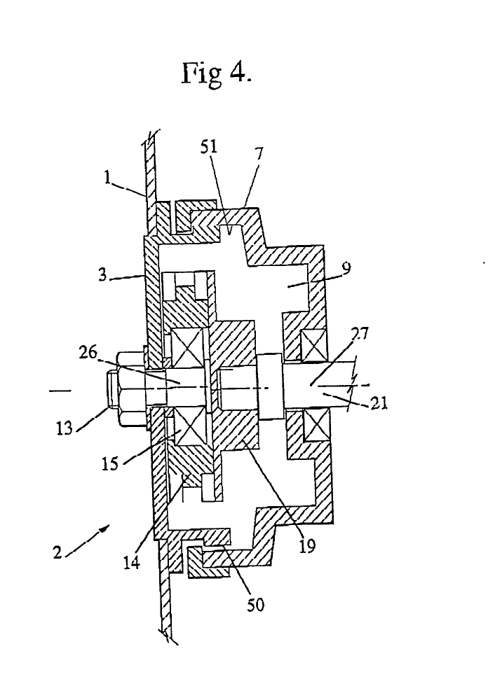

FIG. 4 is a side cross-sectional view of the support means of a second preferred embodiment of the cutting apparatus according to the present invention; and

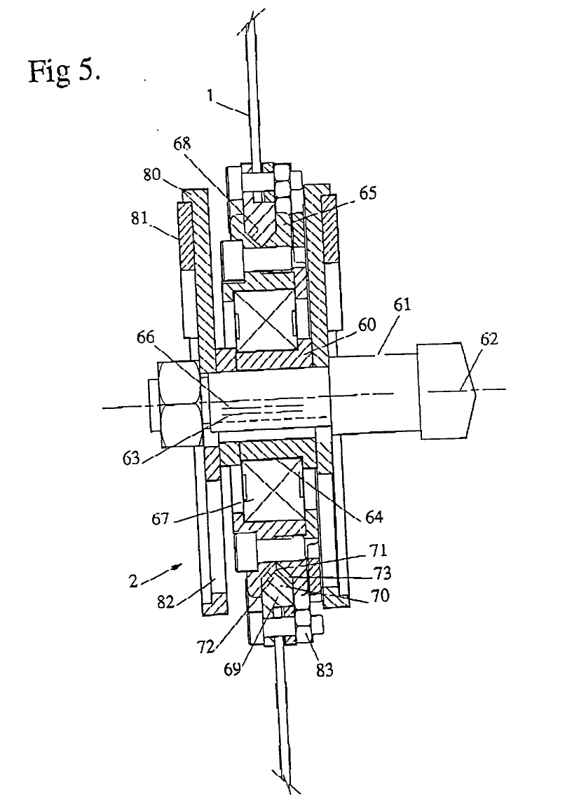

FIG. 5 is a side cross-sectional view of the support means of a third preferred embodiment of the cutting apparatus according to the present invention.

Referring initially to FIGS. 1 and 2, there is shown a cutting apparatus including a generally circular cutting member 1 supported on a support means 2. The support means 2 includes a rotor 3 having an inner cylindrical wall 4. The cutting member 1 can be fastened to the rotor 3 by fastening means 5 on a flange 6 of the rotor 3. The support means 2 also includes a stator 7 which is secured to a main body (not shown) of the cutting apparatus. The stator 7 includes an outer cylindrical wall 8 and an inner cavity 9. An annular rib 10 is provided on the outer cylindrical wall 8 of the stator 7. The flange 6 of the rotor 3 is adapted to cooperate with a ring member 11 having an annular shoulder portion 12. The rotor 3 and the ring 11 can be secured together by the fastening means 5 such that the annular shoulder 12 forms a groove 31 in which the annular rib 10 of the stator 7 can be accommodated.

The rotor 3 is rotatably supported by means of an axle 13 supported on a moveable carriage 14. A bearing 15 is supported on the moveable carriage 14 to provide for rotational movement of the axle 13. A key 16 is provided between the axle 13 and the rotor 3 to ensure that the rotor 3 moves together with the axle 13.

The moveable carriage 14 is slidably supported in a rotatably mounted slide support 19. The moveable carriage 14 has opposing side rails 18 for engaging cooperating slide grooves 17 in the slide support 19. A coil spring 20 is provided between the moveable carriage 14 and the slide support 19. The coil spring 20 urges the moveable carriage 14 out of the slide support 19. This acts to urge the inner cylindrical wall 4 of the rotor 3 against the outer cylindrical wall 8 of the stator 7.

The drive means for the cutting apparatus includes a drive shaft 21 driven by means of a V-belt pulley drive including a driven pulley 22, a V-belt 23, and a drive pulley 24. The drive pulley 24 is driven by means of a power source 25 such as an electric motor.

The drive shaft 21 drives the slide support 19 for rotational movement. The moveable carriage 14 is moveable in a lateral direction relative to the rotational axis 27 of the drive shaft 21. A counter balance 28 is secured by fastening means 29 to the slide support 19. The rotational axis 20 of the axle 13 supporting the rotor 3 is offset relative to the rotational axis 27 of the drive axle 21. This produces an offset drive arrangement which results in the rotor 3 being urged at least in part by centrifugal force against the stator 7. The counter balance 28 on the slide support 19 at least substantially counterbalances the centrifugal force due to the orbital movement of the rotor 3 for rolling motion about the stator 7.

FIG. 3 shows the path of a point on the cutting edge 30 of the cutting member 1. Because of the rolling orbital motion of the rotor 3 supporting the cutting member 1, the cutting edge 30 moves along a “scalloped” path 32 as shown schematically in FIG. 3.

FIG. 4 shows an alternative embodiment of the support means 2 cutting apparatus of the present invention. To facilitate understanding of this embodiment. Components of this embodiment corresponding to components of the embodiment of FIGS. 1 and 2 are designated with the same reference numeral.

The cutting apparatus shown in FIG. 4 operates in a similar way to the embodiment of FIGS. 1 and 2. The cutting member 1 is supported on a rotor 3. The rotor 3 is rotatably supported by an axle 13 on a movable carriage 14 which in turn is slidably supported on a rotatable slide support 19. The slide support 19 is driven by a driveshaft 21. The rotational axis 26 of the axle 13 is offset relative to the rotational axis 27 of the drive shaft 21 in the same manner as in the cutting apparatus of FIG. 1.

The principal difference is that the rotor 3 includes an outer cylindrical wall 50, and the stator 7 has an inner cylindrical wall 51. The diameter of the rotor outer wall 50 is less than the diameter of the stator inner wall 51. Therefore, at least a portion of the rotor 3 can be accommodated within the cavity 9 of the stator 7. When the rotor is driven in Its rolling orbital motion, the rotor outer wall 50 rolls against the stator inner wall 51. This is opposite to the first embodiment of FIGS. 1 and 2 and results in the cutting edge of the cutting member 1 moving somewhat in a different path to the embodiment. Each point on the cutting edge moves in a path defined by a plurality of convex scallops.

FIG. 5 shows yet another embodiment of the support means 2 of the cutting apparatus according to the present invention. The stator in this embodiment is provided by a stator housing 05 extending around a cam 64 and supported on the cam 64 by means of a bearing 67. The cam 60 is mounted on a drive shaft 61 having a central axis of rotation 62. The cam 60 has an at least substantially cylindrical outer support face 64 upon which the bearing 67 is mounted. The axis of symmetry 63 of the cam 60 is laterally offset relative to the drive shaft axis of rotation 62 so that the cam 60 is driven in an eccentric motion. Rotation of the cam 60 therefore results in eccentric motion of the housing 65.

The stator housing 65 provides an annular groove 60 extending about the perimeter of the housing 65. The rotor of the support means 2 of the cutting apparatus of FIG. 5 is in the form of an annular ring 69 having an inner peripheral portion 70 accommodated within the annular groove 68 of the housing 65. FIG. 5 shows the inner peripheral portion 70 of the annular ring 69 tapering to a peripheral inner edge 71. Tie shape of the annular groove 68 generally corresponds to the shape of the inner portion of the annular ring 69, the base 73 of the groove 08 also having tapered sides.

The diameter of the annular ring 69 measured from the peripheral inner edge 71 thereof is greater than the innermost diameter of the base 72 of the annular groove 68 such that a clearance 73 is provided between the said innermost peripheral edge 71 and the base 72 of the annular groove 68. The cutting member 1 is supported on the annular ring 69 and is movable therewith. The axis of symmetry 66 of the annular ring 69 is also offset relative to the drive shaft axis of rotation 62.

A mass balance plate 80 is secured to the end of the drive shaft 61. This plate 80 typically includes a balancing weight 81 and/or apertures 82 provided within the balancing plate 80. This plate 80 rotates with the drive shaft 61 to help to counterbalance the out of balance forces due to the eccentric motion of the cam 60, housing 65, annular plate 69 and cutting member 1. Because the housing 65 rotates in an eccentric motion about the axis of rotation 62 of the drive shaft 61 and because of the clearance 72 provided between the inner periphery at portion 70 of the annular ring and the base 72 of the annular groove 68 of the housing 65, this results in the annular ring 69 and therefore the cutting member 1 being swung around the housing 65 in a similar fashion to a hula hoop moving around a person's waist The annular ring 69 is therefore swung around the housing 65 in the rolling orbital motion because of centrifugal force of the annular ring 69 and the cutting member 1. To facilitate positive movement of the annular ring 69 about the housing 65, a plurality of teeth 83 can be provided on the annular ring 69 for engaging the outer surface of the housing 65. This provides for a more positive drive of the annular ring 69, and therefore the cutting member 1.

The cutting apparatus according to the present Invention is relatively inexpensive to manufacture with the components of the support means for the cutting member being simply turned on a lathe. No expensive cast components are required in the cutting apparatus.

The cutting apparatus can also be manufactured as a relatively compact unit which can be held with one hand and which may still have the ability to cut hard material such as concrete. The cutting apparatus is however safe to use because the cutting member will not readily cut resilient matter such as human tissue because of the relatively low rotational speed of the cutting member.

It should also be appreciated that alternative arrangements could be used to drive the cutting member in a rolling orbital motion about a central area. For example, the cutting member could also be driven by induction, air or hydraulic as well as other mechanical means.

I claim:

1. A cutting apparatus including a generally circular cutting member, and support means for supporting the cutting member for movement about a central area, wherein the cutting member is driven in a rolling orbital motion about the central area during operation of the cutting apparatus.

2. A cutting apparatus according to claim 1 wherein the cutting member has a cutting edge, each point on the cutting edge being driven along a continuous convex scalloped path.

3. A cutting apparatus according to claim 1 wherein the cutting member has a cutting edge, each point on the cutting edge being driven along a continuous concave scalloped path.

4. A cutting apparatus according to claim 1 wherein the support means includes a rotor section and a stator section, the rotor section supports the cutting member and the rotor section is movable relative to the stator section in the rolling orbital motion.

5. A cutting apparatus according to claim 4 wherein the rotor section includes an at least substantially cylindrical inner wall, and the stator section includes an at least substantially cylindrical outer wall, the diameter of the inner wall being greater than the diameter of the outer wall, at least a portion of the outer wall of the stator section being located within the confines of the inner wall of the rotor section such that a point contact is maintained between the inner and outer walls during said rolling orbital motion therebetween.

6. A cutting apparatus according to claim 4 wherein the rotor section includes an at least substantially cylindrical outer wall, and the stator section includes an at least substantially cylindrical inner wall, the diameter of the inner wall being greater than the diameter of the outer wall, at least a portion of the outer wall of the rotor section being located within the confines of the inner wall of the stator section such that a point contact is maintained between the inner and outer walls during said rolling orbital motion.

7. A cutting apparatus according to claim 5 wherein the rotor section is driven for movement relative to the stator position by an offset drive arrangement to thereby drive the rotor section in the rolling orbital motion relative to the stator section.

8. A cutting apparatus according to claim 6 wherein the rotor section is driven for movement relative to the stator position by an offset drive arrangement to thereby drive the rotor section in the rolling orbital motion relative to the stator section.

9. A cutting apparatus according to claim 7 wherein the offset drive arrangement includes a drive shaft, a support means located on and rotatable with the drive shaft, a movable carriage slidably supported on the support means, and a rotor axle rotatably supported on the movable carriage, the rotor section being supported on the rotor axle, wherein the axis of rotation of the rotor axle is laterally offset relative to the axis of rotation of the drive shaft.

10. A cutting apparatus according to claim 8 wherein the offset drive arrangement includes a drive shaft, a support means located on and rotatable with the drive shaft, a movable carriage slidably supported on the support means, and a rotor axle rotatably supported on the movable carriage, the rotor section being supported on the rotor axle, wherein the axis of rotation of the rotor axle is laterally offset relative to the axis of rotation of the drive shaft.

11. A cutting apparatus according to claim 9 further including a resilient; means between the support means and the moveable carriage for urging the rotor section against the stator section.

12. A cutting apparatus according to claim 10 further including a resilient; means between the support means and the moveable carriage for urging the rotor section against the stator section.

13. A cutting apparatus according to claim 4 wherein the stator section is driven for movement in an eccentric motion about a central rotational point, the rotor section being located around the stator section and being urged for movement in said rolling orbital motion about the stator section by the eccentric motion of the stator section.

14. A cutting apparatus according to claim 13 wherein the stator section includes a stator housing having a peripheral annular groove, and the rotor section includes an annular ring having an inner peripheral portion supported within the annular groove, a point contact being maintained between the base of the annular groove and the inner peripheral portion during said rolling orbital motion therebetween.

15. A cutting apparatus according to claim 14 wherein the stator section is driven for movement by an offset drive arrangement including a drive shaft, a cam supported on the drive shaft and having an axis of symmetry laterally offset relative to the axis of rotation of the drive shaft wherein the stator housing is supported on the cam for movement therewith.

16. A cutting apparatus according to claim 4 further including a positive drive means between the stator section and the rotor section.

17. A cutting apparatus according to claim 5 further including a positive drive means between the stator section and the rotor section.

18. A cutting apparatus according to claim 6 further including a positive drive means between the stator section and the rotor section.

19. A cutting apparatus according to claim 7 further including a positive drive means between the stator section and the rotor section.

20. A cutting apparatus according to claim 8 further including a positive drive means between the stator section and the rotor section.

21. A cutting apparatus according to claim 9 further including a positive drive means between the stator section and the rotor section.

22. A cutting apparatus according to claim 10 further including a positive drive means between the stator section and the rotor section.

23. A cutting apparatus according to claim 11 further including a positive drive means between the stator section and the rotor section.

24. A cutting apparatus according to claim 12 further including a positive drive means between the stator section and the rotor section.

25. A cutting apparatus according to claim 13 further including a positive drive means between the stator section and the rotor section.

26. A cutting apparatus according to claim 14 further including a positive drive means between the stator section and the rotor section.

27. A cutting apparatus according to claim 15 further including a positive drive means between the stator section and the rotor section.
